(19) United States
(12) Patent Application Publication
(10) Pub. No.: US 2025/0379945 A1
(43) Pub. Date: Dec. 11, 2025

(54) IMAGE PROCESSING APPARATUS

(71) Applicant: KYOCERA Document Solutions Inc., Osaka (JP)

(72) Inventor: Naoya Miyaji, Osaka (JP)

(21) Appl. No.: 19/229,270

(22) Filed: Jun. 5, 2025

(30) Foreign Application Priority Data
Jun. 10, 2024 (JP) 2024-093486

(51) Int. Cl. H04N 1/00

(52) U.S. Cl. CPC H04N 1/00331; H04N 1/00206; H04N 1/00241; H04N 1/00244

(57) ABSTRACT

An image processing apparatus includes a document image acquiring unit, a character recognition processing unit, and a content list generating unit. The document image acquiring unit is configured to acquire document images of plural pages of a document. The character recognition processing unit is configured to perform a character recognition process for the document images of the plural pages and thereby acquire text data. The content list generating unit is configured to (a) acquire a headline of each page among the plural pages from the text data of the page using a large language model, and (b) generate a content list of the document images of the plural pages on the basis of the acquired headlines of the plural pages.

### CROSS-REFERENCE TO RELATED APPLICATIONS

This application relates to and claims priority rights from Japanese Patent Application No. 2024-093486, filed on Jun. 10, 2024, the entire disclosures of which are hereby incorporated by reference herein.

### BACKGROUND

### 1. Field of the Present Disclosure

The present disclosure relates to an image processing apparatus.

### 2. Description of the Related Art

An electronic apparatus performs a character recognition process for a document image of a document and thereby acquires a text group, detects a headline in the text group and a heading string of a paragraph text in the text group, and arranges the detected headline and the detected heading string and thereby generates a content list.

However, in the aforementioned electronic apparatus, the generated content list may not express contents of the document properly.

### SUMMARY

An image processing apparatus according to an aspect of the present disclosure includes a document image acquiring unit, a character recognition processing unit, and a content list generating unit. The document image acquiring unit is configured to acquire document images of plural pages of a document. The character recognition processing unit is configured to perform a character recognition process for the document images of the plural pages and thereby acquire text data. The content list generating unit is configured to (a) acquire a headline of each page among the plural pages from the text data of the page using a large language model, and (b) generate a content list of the document images of the plural pages on the basis of the acquired headlines of the plural pages.

These and other objects, features and advantages of the present disclosure will become more apparent upon reading of the following detailed description along with the accompanied drawings.

### BRIEF DESCRIPTION OF THE DRAWINGS

FIG. 1 shows block diagram that indicates a configuration of an image processing apparatus according to an embodiment of the present disclosure;

FIG. 2 shows a diagram that explains a format of text data of plural pages;

FIG. 3 shows a diagram that explains a format of text data of plural pages to which a summary and a content list have been added;

FIG. 4 shows a diagram that indicates examples of a page image of a content list and a page image of a summary; and

FIG. 5 shows a flowchart that explains a behavior of the image processing apparatus shown in FIG. 1.

### DETAILED DESCRIPTION

Hereinafter, an embodiment according to an aspect of the present disclosure will be explained with reference to drawings.

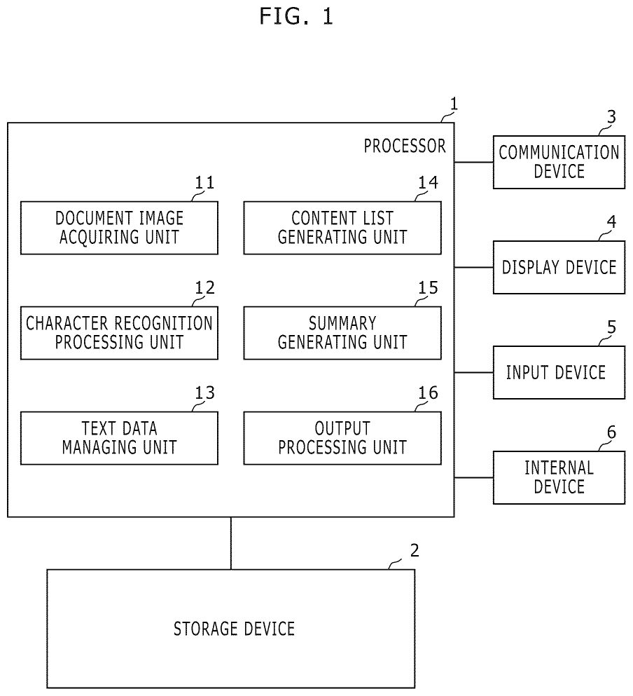

FIG. 1 shows a block diagram that indicates a configuration of an image processing apparatus according to an embodiment of the present disclosure. An image processing apparatus shown in FIG. 1 is an information processing apparatus such as personal computer, electronic apparatus such as digital camera or image forming apparatus (scanner, multi function peripheral or the like), and includes a processor 1, a storage device 2, a communication device 3, a display device 4, an input device 5, an internal device 6 and the like.

The processor 1 includes a computer, and executes program with the computer and thereby, acts as sorts of processing units. Specifically, the computer includes a CPU (Central Processing Unit), a ROM (Read Only Memory), a RAM (Random Access Memory) and the like, loads a program stored in the ROM or the storage device 2, executes the program with the CPU, and thereby acts as sorts of processing units. Further, the processor 1 may include an ASIC (Application Specific Integrated Circuit) that acts as a specific processing unit.

The storage device 2 is a non-volatile storage device such as flash memory, and stores the image processing program and data required for a process mentioned below. In the storage device 2, setting data and the like are stored.

The communication device 3 is a device that performs data communication with an external device, such as network interface or peripheral device interface. The display device 4 is a device that displays sorts of information to a user, such as a display panel of a liquid crystal display. The input device 5 is a device that detects a user operation, such as keyboard or touch panel.

The internal device 6 is a device that performs a specific function of this image processing apparatus. For example, if this image processing apparatus is an image forming apparatus, the internal device 6 is an image scanning device that optically scans a document image from a document, a printing device that prints an image on a print sheet, and/or the like.

Here, the processor 1 acts as the aforementioned processing units a document image acquiring unit 11, a character recognition processing unit 12, a text data managing unit 13, a content list generating unit 14, a summary generating unit 15, and an output processing unit 16.

The document image acquiring unit 11 acquires (image data of) document images of plural pages of a document from the storage device 2, the communication device 3, the internal device 6 or the like and stores (the image data of) the document images into the RAM or the like. For example, the document images are obtained by scanning the document using an image scanning device. Further, the document is a story, a business document or the like, for example.

The character recognition processing unit 12 performs a character recognition process for the document images of the plural pages and thereby acquires text data of a main text in each page of the plural pages.

The text data managing unit 13 associates the text data of each page of the plural pages with a page number of the page.

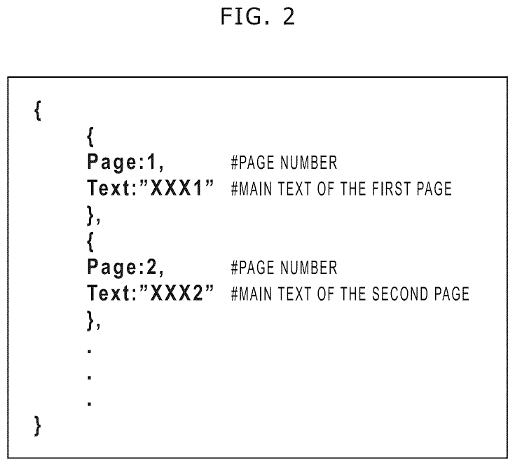

FIG. 2 shows a diagram that explains a format of text data of plural pages. Here, as shown in FIG. 2, for example, the text data managing unit 13 structures the text data of the document images of the plural pages page by page, and thereby generates data in which elements are arranged such that each of the elements includes a page number and text data XXXi (i=1, 2, . . . , N; N is the number of pages) of a page main text for each page.

The content list generating unit 14 (a) acquires a headline of each page among the aforementioned plural pages from the text data of the page using a large language model such as GPT or PaLM, and (b) generates a content list of the document images of the plural pages on the basis of the acquired headlines of the plural pages.

Specifically, using the communication device 3, the content list generating unit 14 accesses a server in which the large language model is installed, generates a prompt that includes (a) the text data of each page and (b) an instruction for generating a headline for the page, inputs the prompt to the large language model, and acquires the headline (text data) of the page from the large language model. Further, the content list generating unit 14 arranges page numbers and the headlines of the aforementioned plural pages page by page and thereby generates a content list of the document images of the plural pages.

The summary generating unit 15 (a) acquires a page summary of each page among the aforementioned plural pages from the text data of the page using the large language model, and (b) generate a summary of the document images of the plural pages on the basis of the acquired page summaries of the plural pages.

Specifically, using the communication device 3, the summary generating unit 15 accesses a server in which the large language model is installed, generates a prompt that includes (a) the text data of each page and (b) an instruction for generating a page summary for the page, inputs the prompt to the large language model, and acquires the page summary (text data) of the page from the large language model.

In this embodiment, the summary generating unit 15 specifies a text style to the large language model when acquiring the page summary.

Specifically, the summary generating unit 15 includes a specification of the text style into the prompt. For example, the specification of the text style is a text in a natural language, such as “as a text that elementary school students can understand” or “as a text in an expert style”.

The aforementioned text style may be selected from a list of such texts by a user or may be set correspondingly to a type of the document (story, business document, or the like). The type of the document may be inputted by a user or may be automatically determined from the document images of the plural pages in accordance with an existing method.

Further, an imaging device may be installed to photograph a user of this image processing apparatus (i.e. a user who is operating the image processing apparatus) and generate a photograph user, the image of the and aforementioned text style may be set correspondingly to a user characteristic (age or the like) determined the from photograph image. The user characteristic is determined by an existing person recognition process or the like from the photograph image.

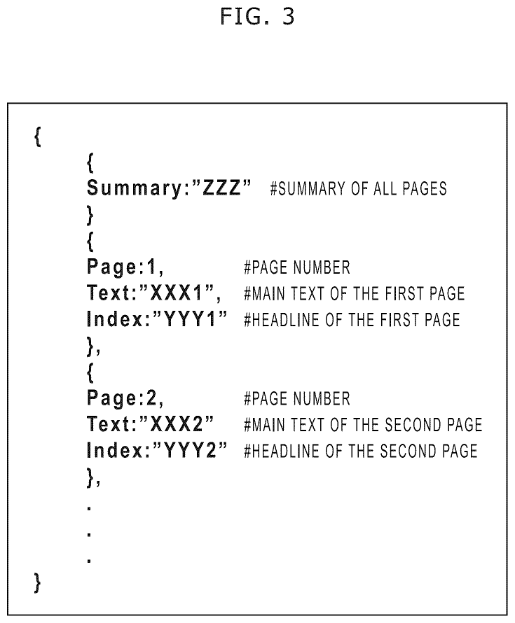

FIG. 3 shows a diagram that explains a format of text data of plural pages to which a summary and a content list have been added. For example, as shown in FIG. 3, a page headline YYYi is inserted and a summary ZZZ is also inserted into the structured text data of the plural pages. The content list may be also inserted into the structured text data of the plural pages as well as the summary ZZZ.

The output processing unit 16 generates a page image of the generated content list and a page image of the generated summary, and performs outputting (printing, data transmission, data saving or the like) of these page images.

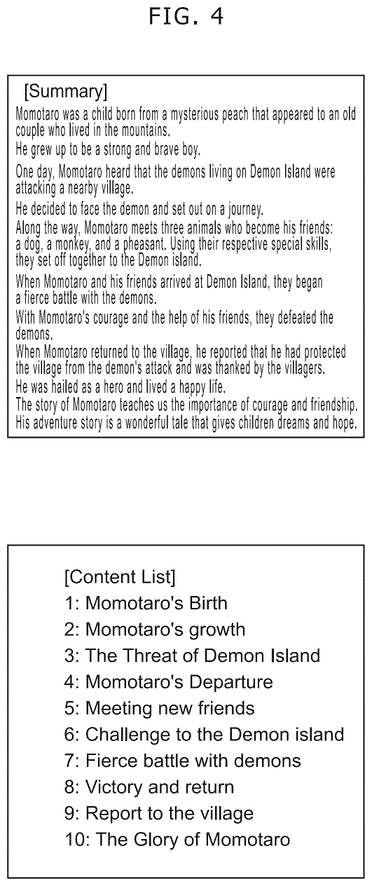

FIG. 4 shows a diagram that indicates examples of a page image of a content list and a page image of a summary. For example, as shown in FIG. 4, a page image of the content list and a page image of the summary are generated. The content list and the summary shown in FIG. 4 are a content list and a summary of document images of a 10-page document, and this document is a document of a Japanese fairy tale “Momotaro”. In the page image of the content list and the page image of the summary, a font size of a text of the content list or the summary is selected such that the whole text fits a single page, and the text is depicted with the font size on the basis of text data of the content list or the summary.

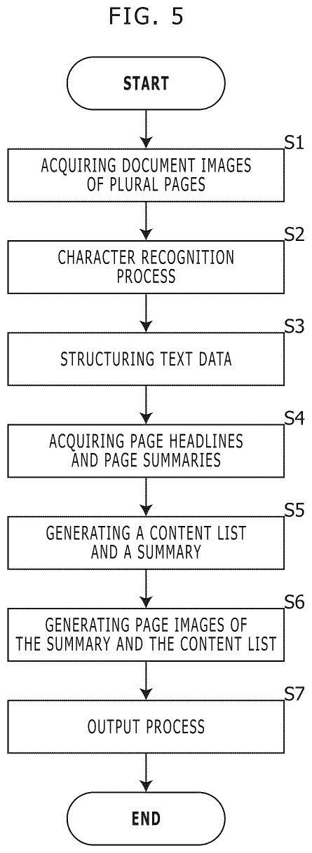

The following part explains a behavior of the aforementioned image processing apparatus. FIG. 5 shows a flowchart that explains a behavior of the image processing apparatus shown in FIG. 1.

When document images of plural pages are acquired by the document image acquiring unit 11 (in Step S1), the character recognition processing unit 12 performs a character recognition process for the document images of the plural pages and thereby acquires text data of the plural pages (in Step S2).

The text data managing unit 13 structures the text data of the document images of the plural pages as shown in FIG. 2, for example (in Step S3).

Subsequently, the content list generating unit 14 acquires a page headline of each page using a large language model, and the summary generating unit 15 acquires a page summary of each page (in Step S4). Afterward, the content list generating unit 14 generates a content list from the page headlines as mentioned, and the summary generating unit 15 generates a summary from the page summaries (in Step S5).

Subsequently, the output processing unit 16 generates a page image of the generated content list and a page image of the generated summary (in Step S6), and performs outputting (printing, data transmission, data saving or the like) of these page images (in Step S7).

As mentioned, in the aforementioned embodiment, the document image acquiring unit 11 acquires document images of plural pages of a document. The character recognition processing unit 12 performs a character recognition process for the document images of the plural pages and thereby acquires text data. The content list generating unit 14 (a) acquires a headline of each page among the plural pages from the text data of the page using a large language model, and (b) generates a content list of the document images of the plural pages on the basis of the acquired headlines of the plural pages.

Consequently, the content list is generated from the page headlines that a content of each page of the document is reflected and therefore, the generated content list properly expresses a content of the document.

It should be understood that various changes and modifications to the embodiments described herein will be apparent to those skilled in the art. Such changes and modifications may be made without departing from the spirit and scope of the present subject and matter d without diminishing its intended advantages. It is therefore intended that such changes and modifications be covered by the appended claims.

For example, in the aforementioned embodiment, the summary generating unit 15 may acquire the summary of document images of the aforementioned plural pages from text data of the aforementioned plural pages using a large language model.

What is claimed is:

1. An image processing apparatus, comprising:
a document image acquiring unit configured to acquire document images of plural pages of a document;
a character recognition processing unit configured to perform a character recognition process for the document images of the plural pages and thereby acquire text data; and
a content list generating unit configured to (a) acquire a headline of each page among the plural pages from the text data of the page using a large language model, and (b) generate a content list of the document images of the plural pages on the basis of the acquired headlines of the plural pages.

2. The image processing apparatus according to claim 1, further comprising a summary generating unit;
wherein the summary generating unit (a) acquires a page summary of each page among the plural pages from the text data of the page using a large language model, and (b) generate a summary of the document images of the plural pages on the basis of the acquired page summaries of the plural pages.

3. The image processing apparatus according to claim 2, wherein the summary generating unit specifies a text style to the large language model when acquiring the page summary; and
the text style is set correspondingly to a type of the document.

4. The image processing apparatus according to claim 2, further comprising an imaging device configured to photograph a user and thereby generate a photograph image of the user;
wherein the summary generating unit specifies a text style to the large language model when acquiring the page summary; and
the text style is set correspondingly to a user characteristic determined from the photograph image of the user.
